(19) United States
(12) Patent Application Publication
(10) Pub. No.: US 2018/0072879 A1
(43) Pub. Date: Mar. 15, 2018

(54) Thermoplastic Elastomer Composition and a Process for its Production

(71) Applicant: CRUMB RUBBER LIMITED, Plymouth Devon (GB)

(72) Inventor: David Young, Plymouth (GB)

(73) Assignee: Crumb Rubber Limited, Plymouth, Devon (GB)

(21) Appl. No.: 15/560,288

(22) PCT Filed: Mar. 18, 2016
(86) PCT No.: PCT/GB2016/050768

§ 371 Date: Sep. 21, 2017

(30) Foreign Application Priority Data
Mar. 23, 2015 (GB) 1504851.5

(51) Int. Cl. C08L 23/12; C08J 3/00

(52) U.S. Cl. CPC C08L 23/12; C08J 3/005; C08L 2555/34; C08L 2207/04; C08J 2417/00; C08J 2451/06; C08J 2323/12

(57) ABSTRACT

An elastomer composition is provided, the composition comprising a polyolefin; crumb rubber; a peroxide; and a polyolefin grafted maleic anhydride. A method of forming the composition is also provided.

The present invention relates to a thermoplastic elastomer composition and a process for its preparation. In particular, the present invention relates to a thermoplastic elastomer composition comprising waste rubber.

There is a continuing need to reduce the adverse environmental impact of used vehicle tyres and to increase the opportunities to recycle materials from used vehicle tyres. It is known to granulate used vehicle tyres to produce rubber crumb of a range of particle sizes. Granulation may be effected in known ways using ambient grinding techniques or cryogenic granulation. Significant work has been carried out to investigate the potential uses for crumb rubber produced from used vehicle tyres. One application that has been explored is to formulate the crumb rubber with a suitable polymer to form an elastomer composition.

The combination of crumb rubber with a polyolefin is known in the art, for example from U.S. Pat. No. 4,795,603, JPH 1046037 and JPS 55135625. A particular problem that has arisen with forming an elastomeric material from crumb rubber and a polymer, such as a polyolefin, is that the two materials are incompatible and do not readily combine. In particular, the crumb rubber does not couple to the polymer particles. Rather, the crumb rubber and polymer particles form a heterogeneous mixture of the components, which leads to a material having a poor mechanical properties. Techniques for improving the mechanical properties of the crumb rubber/polymer composition have been explored in the art.

US 2010/0102468 discloses a process for combining plastic waste materials and crumb rubber and propose the use of a so-called interface treating coupling agent. Little detail is provided regarding the coupling agents that may be used.

JPH 01259048 discloses an elastomer composition obtained by dynamically heat-treating a blend containing a peroxide crosslinkable type olefinic copolymer rubber, preferably an ethylene/propylene non-conjugated diene rubber and/or an olefinic plastic, an unsaturated carboxylic acid or a derivative thereof, preferably maleic anhydride, a monomer containing one or more amino groups, and preferably one or more peroxide uncrosslinkable rubber-like substances, a mineral oil based softener and a fibrous filler in the presence of an organic peroxide. There appears to be no mention of the use of crumb rubber from waste vehicle tyres.

JP2006335879 discloses a maleated product of a crushed vulcanized rubber. The product is prepared by mixing a crushed vulcanized rubber with maleic anhydride in a heating mixer without the use of a peroxide. The maleated regenerated rubber may be combined with hardened products of epoxy and urethane resins to improve the strength at break of the products.

JPH08156188 discloses a composite member prepared by combining a member comprising an epoxy group-containing resin composition and a member comprising an elastic rubber composition having a carboxyl group or an acid anhydride group compounded with a vulcanizing agent to a close contact state and vulcanizing the elastic rubber composition. It is indicated that the effect is to strongly bond both members at the interface between them.

The use of a halogenating agent to treat the surface of a vulcanized rubber article is disclosed in US 2002/074696.

U.S. Pat. No. 6,664,303 discloses a method of producing an elastomeric alloy. In the method, at least one polypropylene copolymer, or a mixture thereof with at least one polypropylene grade, is first melted in a mixer and powdered rubber, of which at least part has been preswelled in a free-radical donor is metered into the melt. The powdered rubber is dispersed in the polymer matrix by application of high shear deformations and with mixing-parameter-dependent addition of free-radical-forming agents for phase coupling between the powdered rubber and the polypropylene copolymer or mixture thereof. The dynamic stabilization process is carried out at a mix temperature which is above the melting point range of the polypropylene copolymer or mixture thereof, but below the decomposition temperature range of the powdered rubber and at a mixing time which allows reaction of the free-radical former.

KR 20000012406 discloses a method for processing waste rubber. The method comprises the steps of: mixing 1 wt % of rubber powder having an average particle size of from 10 to 60 with 0.01 to 0.10 wt % of a surface modifying agent selected from dicumyl peroxide, benzoyl peroxide and sodium benzoate and then agitating. The resulting material is mixed and moulded with 0.01 to 0.20 wt % of a material selected from polyethylene, polypropylene, thermoplastic resins or thermo setting plastic resins of the rubber group and then moulding the resulting mixture by pressurization.

RU 2296780 discloses a method for activating waste rubber materials. The method includes treatment of the waste rubber with an organic solvent containing a monomer or an oligomer and a peroxide, after which the organic solvent is removed to obtain a dry rubber crumb. The monomer or oligomer is selected from monomers or oligomers polymerizing by a free-radical mechanism. The peroxide may be dicumyl peroxide, peroxymone F-40 and cumyl hydroperoxide.

KR 20030093546 discloses a process for preparing a complex material from waste plastic and waste tyre rubber. The waste plastic/ground rubber tyre complex material is obtained by a process comprising the steps of: mixing 10 to 50 wt % of ground rubber tyre powder with waste polyethylene resin; adding 5 to 20 wt % of polypropylene as an organic additive and 5 to 20 wt % of an adhesive resin comprising a polyolefin resin and maleic anhydride in the ratio of 1:0.3 to 0.4 to the waste polyethylene/ground rubber tyre mixture. The mixture is melted at 130 to 180° C. A moulded product of the waste plastic/ground rubber tyre is produced by injection or extrusion moulding.

JPS 56144945 discloses the use of an antioxidant when combining vulcanized rubber powder and an atactic polypropylene.

DE 19607281 discloses a process for recycling scrap and waste rubber to produce a compound with properties similar to a thermoplastic elastomer (TPE). The milled rubber is combined with thermoplastics and cross-linking ingredients in various ratios using a melt mixing process which melts the thermoplastic components. The resulting compound is cooled and can be processed by conventional means to give products with TPE characteristics. Preferably, the milled rubbers have different particle sizes and are used either untreated or activated by various mechanical and/or chemical methods. The thermoplastic component may be a recycled material. Additional ingredients are added in various quantities either before or during the melt mixing process and include sulphur, sulphur-containing, sulphur-dispensing and/or peroxide cross-linking agents; fillers, plasticisers, resins and a compatibiliser. Natural rubber mixtures and/or natural rubber may also be added in various amounts.

CN 101367968 discloses a method for preparing a material from polyethylene and a gelatin powder of waste tyres.

CN102101931 discloses an ultrafine rubber powder/thermoplastic elastomer material.

CN 102604205 discloses a reinforced polypropylene composite for building applications.

CN 103665501 discloses a rubber powder thermoplastic elastomer comprising: 40 to 80 parts of rubber powder, 30 to 50 parts of resin, 2 to 10 parts of a surface modification agent, 5 to 15 parts of a compatilizer, 3 to 8 parts of a plasticizer, 1 to 6 parts of an antiager and 2 to 5 parts of a filling agent. The surface modifier is a mixed methyl vinyl silane, methyl triethoxysilane aniline or a glycol ester titanate. The compatibilizer is a liquid polyisoprene rubber or a liquid polybutadiene rubber.

CN 103483659 discloses a waste-rubber-base polyolefin thermoplastic elastomer material comprising: 40 to 90 parts of waste rubber powder and 10 to 60 parts of polyolefin resin. The preparation method comprises: a) charging the polyolefin resin into a compounding device at a temperature of 100 to 200° C., and melting; b) relative to 100 parts by weight of waste rubber powder-polyolefin resin mixture, adding 0.5 to 8 parts by weight of an in-situ modifier; and c) granulating to obtain the waste-rubber-base thermoplastic elastomer. The polyolefin may be treated with a radical acceptor selected from a sulphur or quinone compound, or a quinoline-based compound. The modifier is selected from diacyl peroxides, dialkyl peroxides, alkyl hydroperoxides, t-alkyl peroxy esters, dialkyl peroxy ketals, dibenzoyl peroxides, dicumyl peroxides or di-t-butyl peroxides.

CN 102516619 discloses a process for preparing a thermoplastic elastomer. The process employs waste rubber crumb, in particular from vehicle tyres, and a polyolefin resin. In the process, the crumb rubber is first combined with an interface modifier, an initiator and a processing oil in a high speed mixer. The polyolefin resin is then added to the mixer, after which the resulting mixture is extruded to provide a granulated elastomer product. Polyolefin resins that may be used in the process are polyethylene, polypropylene, ethylene-vinyl acetate copolymers and mixtures thereof. The crumb rubber has a particle size of from 30 to 200 mesh. The interfacial modifier disclosed in CN 102516619 is maleic anhydride and esters thereof. The initiators that may be used in the process are dicumyl peroxide, dibenzoyl peroxide and di-t-butyl peroxide. The processing oil is white oil or silicone oil.

It has now been found that an improved elastomer composition may be formed by combining crumb rubber, a polyolefin, a peroxide, in particular dicumyl peroxide, and a polyolefin grafted maleic anhydride. In particular, it has been found that the composition has a significantly improved tensile strain at break and a significantly improved impact strength. The composition is also advantageous in that the use of other processing components, such as an oil, is avoided, thereby resulting in a simpler process for forming the elastomer composition.

Accordingly, in a first aspect, the present invention provides an elastomer composition comprising:

a polyolefin;

crumb rubber;

a peroxide; and

a polyolefin grafted maleic anhydride.

The composition of the present invention comprises a polyolefin. The polyolefin may be any suitable polyolefin or mixture of polyolefins. Preferably, the polyolefin is a polymer of an olefin having from 2 to 8 carbon atoms, more preferably from 2 to 6, still more preferably from 3 to 6. A particularly preferred polyolefin is polypropylene.

The polyolefin may be a homopolymer, a block copolymer or a random copolymer. For example, in the case of polypropylene, the polypropylene may be a homopolymer. Alternatively, the polypropylene may be a copolymer, such as a block copolymer or a random copolymer, comprising another olefin moiety, for example comprising from 1 to 20% by weight of ethylene. A polypropylene homopolymer is preferred for many applications.

The polyolefin may be a virgin material, a recycled polyolefin or a mixture thereof.

The polyolefin may be present in the composition in any suitable amount. Preferably, the polyolefin is present in an amount of at least 10% by weight, more preferably at least 20%, still more preferably at least 30%, more preferably still at least 40%. In preferred embodiments, the composition comprises the polyolefin in an amount of at least 50% by weight, preferably at least 60%. Preferably, the polyolefin is present in an amount of from 40 to 95% by weight, more preferably from 45 to 85%, still more preferably from 50 to 80%. A preferred composition is one comprising from 55 to 75% polyolefin, more preferably from 60 to 75%. One preferred embodiment of the composition comprises from 65 to 75% polyolefin, more preferably from 68 to 72%.

The composition further comprises crumb rubber. The crumb rubber is prepared by the granulation of waste rubber. The composition of the present invention is particularly suitable for using crumb rubber prepared from waste or used vehicle tyres. However, crumb rubber formed from other waste rubber articles may also be employed, either alone or in combination with crumb rubber from waste vehicle tyres.

The crumb rubber may be prepared by any suitable technique. Known techniques for producing crumb rubber including grinding at ambient temperatures and cryogenic grinding. It is preferred that the crumb rubber is prepared by grinding at ambient temperatures. It is believed that the morphology of the crumb rubber particles produced by ambient grinding is more advantageous when combining the crumb rubber with a polyolefin.

The crumb rubber may have any suitable particle size. The composition of the present invention may comprise crumb rubber having a single particle size or a range of particle sizes. The particle size of the crumb rubber is preferably no greater than 2000 microns, more preferably no greater than 1500 microns, still more preferably up to 1000 microns, more preferably still up to 750 microns, for example up to 500 microns, in particular up to 250 microns. In a preferred embodiment, the particle size of the crumb rubber is up to 200 microns, preferably up to 150 microns, more preferably up to 100 microns, more preferably still up to 50 microns. A particle size of 40 microns or less provides a composition having a very good tensile strength. The particle size may be in the range of from 1 to 2000 microns, preferably from 2 to 1500 microns, more preferably from 5 to 1000 microns. A preferred particle size is from 10 to 500 microns, more preferably from 10 to 250 microns, still more preferably from 10 to 100 microns. A particle size of from 10 to 50 microns is particularly suitable for many embodiments. In general, smaller particle sizes provide an increased tensile strength for the elastomer composition. However, smaller particle sizes of crumb rubber are generally more costly to produce, in particular on a large or commercial scale. Accordingly, it may be preferred to select a particle size of the crumb rubber that combines a desired level of tensile strength with a low or acceptable cost of production of the crumb rubber. As noted above, to provide a composition having a high tensile strength, a particle size for the crumb rubber of less than 50 microns, more preferably less than 40 microns is most suitable. However, if a balance between improved properties of the elastomer composition and the costs of production is desired, a crumb rubber material of −30 mesh, preferably −35 mesh, still more preferably −40 mesh, is to be preferred.

Preferably, the crumb rubber is present in an amount of at least 5% by weight, more preferably at least 10%, still more preferably at least 15%, more preferably still at least 20%. In preferred embodiments, the composition comprises the polyolefin in an amount of at least 25% by weight, preferably at least 30%.

Preferably, the crumb rubber is present in an amount of from 5 to 90% by weight, more preferably from 5 to 80%, still more preferably from 5 to 70%. A preferred composition is one comprising from 10 to 70% crumb rubber, more preferably from 10 to 75%. One preferred embodiment of the composition comprises from 15 to 60% crumb rubber, more preferably from 15 to 50%.

The composition of the present invention further comprises a peroxide. Suitable peroxides are well known in the art and are commercially available. Preferred peroxides are organic peroxides, more preferably aromatic peroxides, that is peroxides containing a phenyl moiety. One preferred group of peroxides are those comprising a cumyl group, in particular dicumyl peroxide. Dicumyl peroxide (bis(1-methyl-1-phenylethyl) peroxide) is a known peroxide and is commercially available, for example ex. Sigma Aldrich.

The peroxide is present in the composition in any suitable amount. Preferably, the peroxide is present in an amount of up to 2.0% by weight, more preferably up to 1.0%, still more preferably up to 0.5%, more preferably still up to 0.2%. In preferred embodiments, the composition employs the peroxide in an amount up to 0.1% by weight, preferably up to 0.075%. The peroxide may be employed in an amount of from 0.005 to 2.0% by weight, more preferably from 0.01 to 1.0%, still more preferably from 0.02 to 0.5%, more preferably still from 0.03 to 0.2%. In preferred embodiments, the peroxide is employed in an amount of from 0.04 to 0.1% by weight, more preferably from 0.05 to 0.07%.

The peroxide content of the composition may be related to the amount of crumb rubber present. The peroxide may be present in an amount relative to the crumb rubber of at least 0.01 parts per hundred of rubber by weight (phr), preferably at least 0.05 phr, more preferably at least 0.1 phr, and up to 2 phr, preferably up to 1.5 phr, more preferably up to 1.0 phr. A preferred amount of dicumyl peroxide is from 0.05 to 1.5 phr, preferably from 0.075 to 1.0 phr, more preferably from 0.1 to 0.5 phr, still more preferably from 0.15 to 0.4 phr.

The composition of the present invention further comprises a polyolefin grafted maleic anhydride. Maleic anhydride grafted polyolefins are known in the art and are commercially available. The maleic anhydride grafted polyolefins comprise a polyolefin backbone having maleic anhydride groups chemically grafted thereon. A single maleic anhydride grafted polyolefin may be employed or a mixture thereof. The polyolefin of the maleic anhydride grafted polyolefin is preferably a polymer of an olefin having from 2 to 8 carbon atoms, more preferably from 2 to 6, still more preferably from 3 to 6.

It is preferred that the maleic anhydride grafted polyolefin employed comprises a polyolefin that is the same as the or each polyolefin present in the composition. Accordingly, a preferred maleic anhydride grafted polyolefin is polypropylene grafted maleic anhydride.

The polyolefin grafted maleic anhydride is present in the composition in any suitable amount. Preferably, the polyolefin grafted maleic anhydride is present in an amount of up to 20% by weight, more preferably up to 10%, still more preferably up to 5%, more preferably still up to 2%. In preferred embodiments, the composition employs the polyolefin grafted maleic anhydride in an amount up to 1% by weight, preferably up to 0.75%. The polyolefin grafted maleic anhydride may be employed in an amount of from 0.05 to 20% by weight, more preferably from 0.1 to 10%, still more preferably from 0.2 to 5%, more preferably still from 0.3 to 2%. In preferred embodiments, the polyolefin grafted maleic anhydride is employed in an amount of from 0.4 to 1% by weight, more preferably from 0.5 to 0.7%.

The polyolefin grafted maleic anhydride content of the composition may be related to the amount of crumb rubber present. The polyolefin grafted maleic anhydride may be present in an amount relative to the crumb rubber of at least 0.1 parts per hundred of rubber by weight (phr), preferably at least 0.5 phr, more preferably at least 1 phr, and up to 20 phr, preferably up to 15 phr, more preferably up to 10 phr. A preferred amount of polyolefin grafted maleic anhydride is from 0.5 to 15 phr, preferably from 0.75 to 10 phr, more preferably from 1 to 5 phr, still more preferably from 1.5 to 4 phr.

The composition of the present invention may comprise one or more additional components, as are customary in the formulation of elastomers. Examples of such components include fillers, colouring agents, and plasticisers, such as metal stearates, for example zinc stearate and calcium stearate.

The elastomeric composition of the present invention may be provided in any suitable form. In particular, the composition may be provided as granules.

The composition is particularly suitable for processing into elastomeric articles, using techniques known in the art, such as moulding.

In a further aspect, the present invention provides a method for producing an elastomer composition, the method comprising:

combining a polyolefin; crumb rubber; a peroxide; and a polyolefin grafted maleic anhydride; and

mixing the aforementioned components with heating to a temperature above the melting point of the polyolefin.

It is an advantage of the present invention that the process for preparing the elastomer composition may be very simple and employ only a few or, depending upon the equipment employed, a single processing step. In particular, the composition may be formed by combining all of the aforementioned components together and mixing under heating. In contrast to the prior art processes, it is not necessary to combine the components in a particular order or to treat one or more of the components before being combined.

The components are combined and mixed. The components are mixed under heating, whereby the polyolefin is melted. The temperature of the mixing step will be determined by the melting point of the polyolefin and should be high enough to melt the polyolefin, but low enough to avoid thermally degrading any components. For example, in embodiments in which the polyolefin is polypropylene, a temperature in the range of from 170 to 190° C., more preferably from 175 to 185° C., is appropriate.

The components, once combined, may be heated and mixed in any suitable manner. Suitable equipment for use in this step are known in the art and are commercially available. In one preferred embodiment, the components are charged, either together or separately, to the feed hopper of an extruder, whereafter the components are both heated and mixed in the extruder.

The time required for the reactions forming the elastomer composition to complete will depend upon the components being employed and the processing conditions. A reaction time of from 30 seconds to 180 seconds has been found to be very suitable for many embodiments, in particular from 60 to 150 seconds. A reaction time of about 90 seconds is suitable in many cases.

Once the components have been heated and mixed for a sufficient period of time, the resulting composition may be cooled and further processed, for example granulated.

The compositions of the present invention may be prepared using equipment that is known in the art and is commercially available. In particular, the composition may be prepared and the method of the present invention employ an apparatus that comprises a cutter/compactor, in which the components may be combined and mixed, and an extruder. One particularly suitable apparatus is the Corema® system commercially available from EREMA Engineering Recycling Maschinen and Anlagen GmbH. This system provides a convenient and cost effective way to produce the elastomer composition, in particular when using a recycled plastic feedstock, as the recycled material is first cleaned in the system, before being compounded and extruded.

In a still further aspect, the present invention provides an article comprising an elastomer composition as hereinbefore described.

The elastomer composition of the present invention may be formed into an article using a range of techniques known in the art. The composition is particularly suitable for moulding, for example injection moulding.

Embodiments of the present invention will now be described, for illustration purposes only, by way of the following examples.

### EXAMPLES

### Example 1

### Preparation of Crumb Rubber/polypropylene Elastomer

A crumb rubber/polypropylene elastomer composition was prepared from the components set out in Table 1.

TABLE 1

| | Amount |
|---|---|
| Component | (% wt. of total composition) |
| Polypropylene | 69.24 |
| (relative density 0.91 g/cm³) | |
| Crumb Rubber | 30.10 |
| Polypropylene grafted maleic anhydride | 0.60 |
| (Polyram Bondyram ® pellets) | (equivalent to 2 phr) |
| Dicumyl peroxide | 0.06 |
| (98% purity; ex. Sigma Aldrich) | (equivalent to 0.2 phr) |

The components set out in Table 1 were combined and charged together to the feed hopper of a co-kneading extruder (ex. Buss).

The extruder was operated at a barrel temperature of from 175 to 185° C. and a die temperature about 10° C. higher than the barrel temperature. The operating temperature was controlled using a thermal infra red camera. The product was allowed to cool to ambient temperature and was granulated.

An elastomer composition having a density of 0.96 g/cm³ was obtained.

For comparison purposes, the experiment was repeated using the same equipment and operating conditions, with the exception that the polypropylene grafted maleic anhydride and dicumyl peroxide were omitted. This composition is hereafter designated ‘Comparison A’.

### Example 2

### Compression Moulding

The mechanical strength of the elastomer composition of Example 1 and Comparison A was tested using the following procedure.

The samples were subject to compression moulding using a Bipel/Bytec 40 tonne hydraulic press with hot platens having a temperature range of up to 400° C. The samples were pressed into sheets under a vacuum following a four stage process in accordance with ISO standard 293 ‘Plastics-Compression Moulding Test Specimens of Thermoplastic Materials’.

In a first stage, each sample was pre-heated on the press for 5 minutes at 190° C. with contact pressure. Thereafter, each sample was subjected to a series of compression sequences. In each sequence, the material was compressed at 190° C. for 1 min at 240 kN, after which the pressure was relieved for 1 minute in order to ensure that gas bubbles were removed. This sequence was repeated three times. Thereafter, each sample was compressed for 3 to 5 minutes at 190° C. and 240 kN. Finally, each sample was cooled down slowly at room temperature.

After cooling, the sheets were removed from the mould and conditioned for at least one day.

Dumb-bell test specimens were made from each sample, using a test specimen cutter, and were tested according to the procedures of ISO standard 527:2012.

The above procedure was followed for a sample of 100% virgin polypropylene. The differences in the tensile stress at break, the tensile strain at break and the impact strength between the samples of each of Example 1 and Comparison A and the sample of polypropylene were determined.

The results of the tests are set out in Table 2 below. The results in Table 2 indicate the percentage change of the indicated property compared to the same property of pure polypropylene (taking the value of the relevant property of polypropylene as 0%).

TABLE 2

| | Tensile Stress | Tensile Strain | Impact |
|---|---|---|---|
| | at Break | at Break | Strength |
| Comparison A | −30% | −3% | −23% |
| Example 1 | −33% | +57% | −11% |

As can be seen from Table 2, the composition of the present invention exhibited a significantly increased tensile strain at break, compared with the sample of Comparison A and the pure polypropylene. In addition, the composition of the present invention exhibited a significantly higher impact strength than the sample of Comparison A.

### Example 3

### Injection Moulding

The mechanical strength of the elastomer composition of Example 1 and Comparison A was tested using the following procedure.

The materials were moulded using a Battenfeld HM40/130 injection moulding machine, with the barrel and nozzle temperatures set at 195° C. The processing conditions used are summarised in Table 3.

TABLE 3

| | |
|---|---|
| Injection pressure: | 500 bar |
| Injection speed: | 50 ccm/s |
| Holding pressure: | 800 bar/10 sec |
| Screw back | 100 mm/s |
| Injection volume | 13 ccm |
| Back pressure | 5 bar |
| Cooling time | 10 sec |
| Mould temp | 40° C. |
| Melt cushion | 2-3 ccm |

The tensile stress and tensile strain of the moulded samples was measured. The results are set out in Table 4 below.

TABLE 4

| | Tensile Stress at | Tensile Strain at |
|---|---|---|
| | Break | Break |
| | (MPa) | (%) |
| Comparison A | 12 | 43 |
| Example 1 | 13 | 64 |

As can be seen from Table 4, the composition of the present invention exhibited an increased tensile stress and a significantly increased tensile strain, compared with the sample of Comparison A.

### Examples 4 to 7

### Varying Dicumyl Peroxide Content

The procedures of Examples 1 and 2 were repeated to prepare and test the compositions of the present invention with a range of different dicumyl peroxide contents. The compositions of the samples prepared are summarised in Table 5 below. As with Example 1, a comparison composition was prepared, designated ‘Comparison B’.

TABLE 5

| | Example 4 | Example 5 | Example 6 | Example 7 | Comparison B |
|---|---|---|---|---|---|
| Polypropylene | 70% | 70% | 70% | 70% | 70% |
| (relative density | | | | | |
| 0.91 g/cm³) | | | | | |
| Crumb Rubber | 30% | 30% | 30% | 30% | 30% |
| Polypropylene | 2 phr | 2 phr | 2 phr | 2 phr | — |
| grafted maleic | | | | | |
| anhydride | | | | | |
| (Polyram | | | | | |
| Bondyram ® | | | | | |
| pellets) | | | | | |
| Dicumyl | 0.1 phr | 0.2 phr | 0.3 phr | 1 phr | — |
| peroxide | | | | | |
| (98% purity; ex. | | | | | |
| Sigma Aldrich) | | | | | |

The results of the tensile tests for Examples 4 to 7 and Comparison B are summarised in Table 6 below. For each property measured, the actual value of the property is indicated as a percentage change with respect to the comparison sample.

TABLE 6

| | Tensile Stress at | Tensile Strain at |
|---|---|---|
| | Break | Break |
| Comparison B | 0% | 0% |
| Example 4 | −18% | +46% |
| Example 5 | −5% | +63% |
| Example 6 | −9% | +28% |
| Example 7 | −12% | −7% |

As can be seen from Table 6, the compositions of the present invention exhibited a significantly increased tensile strain at break, compared with the sample of Comparison B.

### Examples 8 and 9

### Varying Polyolefin Grafted Maleic Anhydride Content

The procedures of Examples 1 and 2 were repeated to prepare and test the compositions of the present invention with a range of different polyolefin grafted maleic anhydride contents. The compositions of the samples prepared are summarised in Table 7 below. As with Example 1, a comparison composition was prepared, designated ‘Comparison C’.

TABLE 7

| | Example 8 | Example 9 | Comparison C |
|---|---|---|---|
| Polypropylene | 70% | 70% | 70% |
| (relative density | | | |
| 0.91 g/cm³) | | | |
| Crumb Rubber | 30% | 30% | 30% |
| Polypropylene | 2 phr | 4 phr | — |
| grafted maleic | | | |
| anhydride | | | |
| (Polyram | | | |
| Bondyram ® | | | |
| pellets) | | | |
| Dicumyl | 0.2 phr | 0.2 phr | — |
| peroxide | | | |
| (98% purity; ex. | | | |
| Sigma Aldrich) | | | |

The results of the tests to measure tensile stress and tensile strain are summarised in Table 8 below. For each property measured, the actual value of the property is indicated as a percentage change with respect to the comparison sample.

TABLE 8

| | Tensile Stress at | Tensile Strain at |
|---|---|---|
| | Break | Break |
| Comparison C | 0% | 0% |
| Example 8 | −5% | +63% |
| Example 9 | −16% | +70% |

As can be seen from Table 8, the compositions of the present invention exhibited a significantly increased tensile strain at break, compared with the sample of Comparison C.

### Examples 10 and 11

### Varying Crumb Rubber Particle Size

The procedures of Examples 1 and 2 were repeated to prepare and test the compositions of the present invention with a range of different particle sizes of crumb rubber. The compositions of the samples prepared are summarised in Table 9 below.

TABLE 9

| | Example 9 | Example 10 |
|---|---|---|
| Polypropylene | 70% | 70% |
| (relative density | | |
| 0.91 g/cm³) | | |
| Crumb Rubber | 30% | 30% |
| Crumb Rubber | 40 mesh | 80 mesh |
| particle size | | |
| Polypropylene | 2 phr | 2 phr |
| grafted maleic | | |
| anhydride | | |
| (Polyram | | |
| Bondyram ® | | |
| pellets) | | |
| Dicumyl | 0.2 phr | 0.2 phr |
| peroxide | | |
| (98% purity; ex. | | |
| Sigma Aldrich) | | |

The results of the tests to measure tensile stress and tensile strain are summarised in Table 10 below.

TABLE 10

| | Tensile Stress | Tensile Strain |
|---|---|---|
| | (MPa) | (%) |
| Example 9 | 12 | 11 |
| Example 10 | 14 | 10 |

### Example 12

### Cyclic Testing

Samples of the material prepared in Example 1 and of Comparison A were moulded as described in Example 3 and subjected to cyclic compression testing. The samples were subjected to repeated cycles of compression, with each cycle comprising compressing the sample to 720 N and then decompression to 0 N. The rate of compression and decompression was varied.

The results are set out in Table 11 below.

TABLE 11

Number of cycles

| Cycle rate (kN/s) | Comparison A | Example 1 |
|---|---|---|
| 0.2 | 43 | 100* |
| 0.4 | 100* | 100* |
| 0.6 | 103 | 190 |
| 1 | 360 | 783 |

*Indicates a test that was stopped after 100 cycles.

As can be seen from the results in Table 11, the sample of Example 1 performed significantly better than the sample of Comparison A, in particular exhibiting a significantly better tolerance to compression cycles before failure.

1-58. (canceled)

59. An elastomer composition comprising:
a polyolefin;
crumb rubber;
a peroxide; and
a polyolefin grafted maleic anhydride.

60. The elastomer composition according to claim 59, wherein the polyolefin comprises polypropylene.

61. The elastomer composition according to claim 59, wherein the polyolefin is a homopolymer.

62. The elastomer composition according to claim 59, wherein the polyolefin is present in an amount of at least 60% by weight.

63. The elastomer composition according to claim 59, wherein the crumb rubber is prepared from waste or used vehicle tyres.

64. The elastomer composition according to claim 59, wherein the crumb rubber has a particle size of from 10 to 250 microns.

65. The elastomer composition according to claim 59, wherein the crumb rubber is present in an amount of from 10 to 75% by weight.

66. The elastomer composition according to claim 59, wherein the peroxide comprises dicumyl peroxide (DCP).

67. The elastomer composition according to claim 59, wherein the peroxide is present in an amount of at least 0.05 parts per hundred of rubber by weight.

68. The elastomer composition according to claim 59, wherein the polyolefin grafted maleic anhydride comprises a polyolefin the same as the polyolefin.

69. The elastomer composition according to claim 68, wherein the polyolefin of the polyolefin grafted maleic anhydride is polypropylene.

70. The elastomer composition according to claim 59, wherein the polyolefin grafted maleic anhydride is present in an amount of at least 0.5 parts per hundred of rubber by weight.

71. A method for producing an elastomer composition, the method comprising:
combining a polyolefin; crumb rubber; a peroxide; and a polyolefin grafted maleic anhydride; and
mixing the aforementioned components with heating to a temperature above the melting point of the polyolefin.

72. The method according to claim 71, wherein the polyolefin comprises polypropylene.

73. The method according to claim 71, wherein the polyolefin is present in an amount of at least 60% by weight.

74. The method according to claim 71, wherein the crumb rubber is prepared from waste or used vehicle tyres.

75. The method according to claim 71, wherein the crumb rubber has a particle size of from 10 to 250 microns.

76. The method according to claim 71, wherein the crumb rubber is present in an amount of from 10 to 75% by weight.

77. The method according to claim 71, wherein the peroxide comprises dicumyl peroxide (DCP).

78. The method according to claim 71, wherein the polyolefin of the polyolefin grafted maleic anhydride is polypropylene.

79. The method according to claim 71, wherein the polyolefin grafted maleic anhydride is present in an amount of at least 0.5 parts per hundred of rubber by weight.
